(19) United States
(12) Patent Application Publication
(10) Pub. No.: US 2022/0082249 A1
(43) Pub. Date: Mar. 17, 2022

(54) FLAT ROOF CHEMICAL LOOPING COMBUSTION REACTOR

(71) Applicants: IFP Energies nouvelles, Rueil-Malmaison Cedex (FR); TOTAL RAFFINAGE CHIMIE, COURBEVOIE (FR)

(72) Inventors: Ann CLOUPET, RUEIL-MALMAISON CEDEX (FR); Sina TEBIANIAN, RUEIL-MALMAISON CEDEX (FR); Florent GUILLOU, RUEIL-MALMAISON CEDEX (FR); Stephane BERTHOLIN, RUEIL-MALMAISON CEDEX (FR); Airy TILLAND, RUEIL-MALMAISON CEDEX (FR); Benjamin AMBLARD, RUEIL-MALMAISON CEDEX (FR); Mahdi YAZDANPANAH, LE HAVRE (FR); Surya REDDY KARRI, NAPERVILLE, IL (US); Tedd KNOWLTON, WILLOWBROOK, IL (US)

(21) Appl. No.: 17/414,784

(22) PCT Filed: Dec. 10, 2019
(86) PCT No.: PCT/EP2019/084511

§ 371 Date: Jun. 16, 2021

(30) Foreign Application Priority Data
Dec. 17, 2018 (FR) 1873092

(51) Int. Cl. F23C 10/18; F23C 10/00

(52) U.S. Cl. CPC F23C 10/18; F23C 2900/99008; F23C 10/005

(57) ABSTRACT

The present invention concerns a combustion reactor (300) for chemical looping combustion (CLC) configured to operate in a fluidised bed, comprising:
a lower chamber (320) forming a first reaction zone for the combustion of a hydrocarbon feedstock in the presence of particles of an oxidation-reduction active mass, comprising a first side wall and being configured to include a dense fluidised bed;
an elongate upper chamber (340) with smaller passage cross-section than that of the lower chamber, forming a second reaction zone for the combustion of gaseous effluents originating from the combustion in the lower portion, comprising a second side wall and being configured to include a dilute fluidised bed;
an intermediate portion (330) connecting the two chambers, and including an inner wall forming a right angle with the side walls of the two chambers. The invention also relates to the facility and the CLC process incorporating such a reactor (300).

### TECHNICAL FIELD

The present invention relates to the field of the combustion of hydrocarbon feedstocks by chemical looping oxidation/reduction (CLC) operating as fluidized bed, and more specifically relates to a CLC combustion reactor operating as fluidized bed which is particularly well suited to the combustion of solid or liquid hydrocarbon feedstocks.

### PRIOR ART

The chemical looping combustion (CLC) process is a process consisting in carrying out oxidation/reduction reactions of an active mass, typically a metal oxide, in order to break the reaction for the combustion of a hydrocarbon feedstock down into two successive reactions:

a first reaction of oxidation of the active mass in contact with an oxidizing gas, typically air, in at least one oxidation zone, and a second reaction of reduction of the active mass in contact with the feedstock, the combustion of which is desired, in at least one combustion zone.

The oxidation/reduction active mass, which gives up a part of the oxygen which it contains in contact with the feedstock in the combustion zone, thus acts as oxygen transporter between said combustion zone and the oxidation zone, where it is oxidized again.

This solid material is provided in the form of fluidizable particles, belonging to groups A, B or C of the Geldart classification, which is based on the size of the particles and on their difference in density from the gas, and often to group B. The particles are brought into contact in the reaction zones, with either the oxidizing gas or the feedstock, in the form of fluidized beds, and are generally transported from one zone to another in a fluidized form. The body of particles transported in a fluidized form is commonly referred to as a circulating or transported fluidized bed.

These particles are oxidized in contact with an oxidizing gas, typically air (or water vapor), in at least one first reaction zone, called oxidation reactor or air reactor. They are subsequently transported into at least one second reaction zone, called reduction reactor or combustion reactor or fuel reactor, where they are brought into contact with a solid (e.g., coal, coke, pet-coke, biomass, tar sands, household waste), liquid (e.g., fuel oil, bitumen, diesel, gasolines, shale oil, and the like) or gaseous (e.g., natural gas, syngas, biogas, shale gas) hydrocarbon feedstock, the combustion of which it is desired to carry out. The oxygen transported by the particles of the active mass feeds the combustion of the feedstock. This results in a gaseous effluent formed by the combustion of the feedstock and a stream of reduced particles. The particles are returned to the air reactor to be reoxidized therein, thus closing the loop.

The CLC process makes it possible to produce energy (steam, electricity, and the like) by recovery of the heat given off by the combustion reactions while facilitating the capture of the carbon dioxide (CO₂) emitted during the combustion by virtue of the production of flue gases rich in CO₂. This is because the CO₂ can be captured after condensation of the water vapor and compression of the flue gases, and it can then be stored, for example in a deep aquifer, or be upgraded, for example by employing it for improving the output of oil operations in enhanced oil recovery (EOR) or enhanced gas recovery (EGR) processes.

The CLC process can also make possible the production of synthesis gas, indeed even of hydrogen, by controlling the combustion and by carrying out the required purifications downstream of the combustion process.

Another advantage results from this mode of combustion: the production of a stream very rich in nitrogen, which is the depleted air obtained on conclusion of the oxidation of the active mass in the air reactor. Depending on the degree of purity achieved, this nitrogen stream can be upgraded in various applications, in particular in the field of the oil industry. It can, for example, be used in refineries as inert gas in various oil refining processes or for the treatment of production waters, or as gas injected into the subsoil in EOR processes.

Different fluidization regimes can be employed in the different units of the CLC plant, in particular in the oxidation and reduction reactors operating as fluidized bed. This is because the fluidization regime applied depends on the operation to be carried out (combustion of the feedstock, oxidation of the particles of the oxygen carrier, transportation of the particles, solid/solid separation, solid/gas separation) and on the type of feedstock treated.

For example, the combustion of a solid feedstock, itself in the form of particles, requires a greater time of contact with the particles of the oxygen carrier than the combustion of a gaseous feedstock, which is generally reflected by the use in the combustion reactor of a zone comprising a dense fluidized bed, operating according to a heterogeneous fluidization regime corresponding to a bed referred to as ebullated (presence of bubbles in the bed) or turbulent (preferred flow regime), in which the particles of the oxygen carrier and of the solid feedstock are brought into contact for a first combustion stage consisting essentially of a gasification of the solid feedstock. A second stage is generally necessary to tend toward total combustion, with the particles of the oxygen carrier and the gasified feedstock being brought into contact. This second stage is generally carried out in the first reaction zone, and can also be carried out in a second reaction zone comprising a dilute fluidized bed, operating according to a transported fluidization regime (corresponding to the regime of the circulating fluidized beds) involving higher gas velocities. This reaction zone generally corresponds to a part of the reactor forming a substantially elongated and vertical pipe commonly called “riser”, a term commonly used by a person skilled in the art. Such a configuration involving a first combustion zone as dense fluidized bed surmounted by a second combustion zone of riser type operating as dense fluidized bed is, for example, described in the patent application WO11151535 relating to a CLC process specific to solid hydrocarbon feedstocks.

In the case of the chemical looping combustion of gaseous feedstocks, as the contact time required between the particles of the active mass and the feedstock is less than in the case of solid or liquid feedstocks, a riser-type reactor may be sufficient to carry out the combustion of the feedstock.

Generally, increasing the gas velocity in a fluidized bed generates different flow regimes. Depending on the group of the Geldart classification to which the solid particles belong, different fluidization regimes are possible when the velocity of the gas increases.

With particles of group B of the Geldart classification, for example, on gradually increasing the gas flow rate, the flow changes from the bubble regime (ebullated bed, which is a dense bed), to the plug-flow regime, called slugging (depending on the bed height and bed diameter), to the turbulent regime, to the rapid fluidization regime (circulating bed) and then to the transportation regime. Although at low velocity of the gas the fluidization regime may differ according to the group of the particles, they all reach, whatever their group, a turbulent fluidization regime, then a rapid fluidization regime, followed by a transportation regime when the velocity of the gas increases.

The plug-flow regime appears when the diameter of the bubbles becomes comparable to the diameter of the column: with particles of group B, the bubbles enlarge as they rise in the reactor, it being possible for their size to reach the diameter of the reactor in the extreme. In this case, the regime reached is that of plug-flow, generating flows as “plugs”. Large bubbles burst at the surface of the bed or on the wall, with dense agglomerates of solid entrained in their wake, generating strong flow heterogeneities, and being expressed by strong pressure fluctuations and by vibrations.

The turbulent regime is for its part particularly advantageous for industrial processes because it exhibits a much more homogeneous mixing of the phases and a very significant mass and heat transfer, compared to the ebullated and plug-flow regimes. It is a regime which corresponds to strong agitation of the particles: as the fluidization velocity increases, the size and the number of the bubbles gradually increase and the agitation of the suspension becomes increasingly violent. This agitation is produced by the rise of the bubbles and by the fact that they entrain a part of the suspension in their wake. At high velocities, the shape of the bubbles becomes irregular. Nevertheless, even if the large bubbles formed do not achieve the diameter of the reactor, they can generate large fluctuations in pressure and vibrations within the bed, typically during their breakage within the bed, on the surface of the bed and on the walls of the reactor.

The plug-flow regime as well as the formation of large bubbles are thus undesirable for several reasons: the mixing of the solid and gas is poorer (less homogeneous), the homogeneity of the temperature of the reactor is no longer ensured, and the strong fluctuations in pressure and vibrations on the walls and the bottom of the reactor are harmful to the mechanical strength of the reactor.

In the case of a fluidized bed reactor connected by its upper part to an elongated pipe of smaller diameter (riser), such as the CLC reactor mentioned above and described in the application WO11151535, the formation of large bubbles can prove to be all the more problematic as the dense agglomerates of solid entrained can in their turn cause a plug-flow phenomenon in the elongated pipe.

Devices for reducing the plug-flow phenomenon are known. For example, the U.S. Pat. No. 9,512,364 B2, relating to a hydropyrolysis process for the transformation of biomass in the form of particles into liquid fuels employing catalytic ebullated beds, discloses an anti-plug-flow reactor comprising lateral inserts, which are elements of obstacle, of obstruction or of constriction placed at regular intervals in the bed in order to inhibit plug flow in the reactor. Such inserts are not always easy to employ, and this type of reactor may require significant maintenance linked to the possible coking of the inserts.

The present invention proposes to provide another solution dedicated to CLC to reduce the problems associated with the plug-flow phenomenon, in particular to limit the strong fluctuations in pressure in the combustion reactor and especially in the elongated part of the reactor (riser).

### OBJECTIVES AND SUMMARY OF THE INVENTION

The objective of the present invention is to provide a CLC combustion reactor making it possible to limit the undesirable effects generated by the employment of turbulence and plug-flow fluidization regimes in the reactor, in particular to limit the strong fluctuations in pressure caused by the formation of large bubbles and their bursting. It is thus targeted at preserving the mechanical strength of the combustion reactor, at ensuring temperature homogeneity in the reactor, as well as at ensuring homogeneity of the gas/particles mixture in the reactor for the purpose of optimum combustion.

Thus, in order to achieve at least one of the objectives targeted above, among others, the present invention proposes, according to a first aspect, a combustion reactor for chemical looping combustion configured to operate as fluidized bed comprising:
a lower chamber forming a first reaction zone for the combustion of a hydrocarbon feedstock in the presence of particles of an oxidation/reduction active mass, said lower chamber comprising a first side wall and being configured to comprise a dense fluidized bed;
an upper chamber of elongated shape and having a smaller passage section than the passage section of said lower chamber, forming a second reaction zone for the combustion of the gaseous effluents resulting from the combustion in said lower part, said upper chamber comprising a second side wall and being configured to comprise a dilute fluidized bed;
an intermediate part connecting said lower chamber to said upper chamber, said intermediate part comprising an internal wall forming a right angle with the first side wall of the lower chamber and with the second side wall of the upper chamber.

According to one embodiment, the lower chamber comprises a main injection system for a main fluidization gas positioned at the base of the lower chamber.

According to one embodiment, the lower chamber additionally comprises a secondary injection system for a secondary fluidization gas positioned at the top of the lower chamber.

According to one embodiment, the lower chamber additionally comprises a tertiary injection system for a tertiary fluidization gas positioned between the main injection system and the top of the lower chamber, configured to control the level of the dense bed.

According to one embodiment, the upper part of the combustion reactor comprises a segment penetrating into the lower part of the chamber by a height h preferably of between 0.01×H and 0.3×H, H being the height of the lower chamber of the combustion reactor.

According to one embodiment, the ratio of the passage section of the lower chamber to the passage section of the upper chamber is between 2 and 15, and preferably between 3 and 10.

According to one embodiment, the lower and upper chambers of the reactor have a parallelepipedal, preferably rectangular, shape.

According to a second aspect, the present invention proposes a plant for the chemical looping combustion of a hydrocarbon feedstock employing particles of an oxidation/reduction active mass circulating between a combustion reactor and an oxidation reactor, comprising:
the combustion reactor according to the invention operating as fluidized bed to carry out the combustion of said hydrocarbon feedstock in contact with said particles of the oxidation/reduction active mass;
the oxidation reactor operating as fluidized bed in order to oxidize the reduced particles of the oxidation/reduction active mass originating from the combustion reactor by bringing into contact with an oxidizing gas.

According to yet a third aspect, the present invention proposes a process for the chemical looping combustion of a hydrocarbon feedstock employing a combustion reactor according to the invention or the plant according to the invention, comprising the following stages:
particles of an oxidation/reduction active mass are brought into contact with the hydrocarbon feedstock in the lower chamber of the combustion reactor within a dense fluidized bed formed by the injection of a main fluidization gas;
combustion of the gaseous effluents resulting from the lower chamber is carried out in the presence of particles of the oxidation/reduction active mass in the upper chamber of the combustion reactor, within a dilute fluidized bed;
oxidation of the particles of the oxidation/reduction active mass which have stayed in the combustion reactor is carried out within an oxidation reactor operating as fluidized bed before returning them to the combustion reactor.

According to one embodiment, the hydrocarbon feedstock is a solid feedstock, preferably chosen from coal, coke, pet-coke, biomass, tar sands and household waste.

According to one embodiment, separation of particles of unburnt residues and particles of the oxidation/reduction active mass contained in a gas mixture comprising combustion gases resulting from the upper chamber of the combustion reactor can be carried out in a solid/solid particles separator; the particles of the oxidation/reduction active mass thus separated are sent to the oxidation reactor, and the particles of unburnt residues, optionally separated from the combustion gases in at least one gas/solid separation stage, are recycled in the combustion reactor.

According to one embodiment, the superficial velocity of the gas in the lower chamber of the combustion reactor is between 0.3 m/s and 3 m/s, and in which the superficial velocity of the gas in the upper chamber of the combustion reactor is between 3 m/s and 15 m/s.

According to one embodiment, the temperature in the combustion reactor is between 600° C. and 1400° C., preferably between 800° C. and 1000° C.

According to one embodiment, a secondary fluidization gas is injected at the top of the lower chamber of the combustion reactor, preferably forming a jet along a direction forming an angle β of between 0 and 90° with the vertical.

Preferably, the flow rate of the secondary fluidization gas is between 0.02×Q_{MG} and 0.2×Q_{MG}, Q_{MG} being the flow rate of the main fluidization gas.

According to one embodiment, a tertiary fluidization gas is injected into a zone of the dense bed in the lower chamber of the combustion reactor so as to control the level of the dense bed.

According to one embodiment, the particles of the oxidation/reduction active mass belong to group B according to the Geldart classification.

Other subject matters and advantages of the invention will become apparent on reading the description which follows of specific exemplary embodiments of the invention, given by way of nonlimiting examples, the description being made with reference to the appended figures described below.

### LIST OF THE FIGURES

FIG. 1 is an implementational block diagram of a CLC process.

FIG. 2 represents a CLC combustion reactor according to the prior art.

FIG. 3 represents a CLC combustion reactor according to a first embodiment of the invention.

FIG. 4 represents a CLC combustion reactor according to a second embodiment of the invention.

In the figures, the same references denote identical or analogous elements.

### DESCRIPTION OF THE EMBODIMENTS

The object of the invention is to propose a combustion reactor for chemical looping combustion with a specific geometry suitable for the combustion of solid or liquid hydrocarbon feedstocks, and preferably of solid feedstocks, making it possible to limit the strong fluctuations in pressure associated with the presence of large bubbles and with the plug-flow phenomenon which are encountered in placing fluidized beds under a turbulent regime.

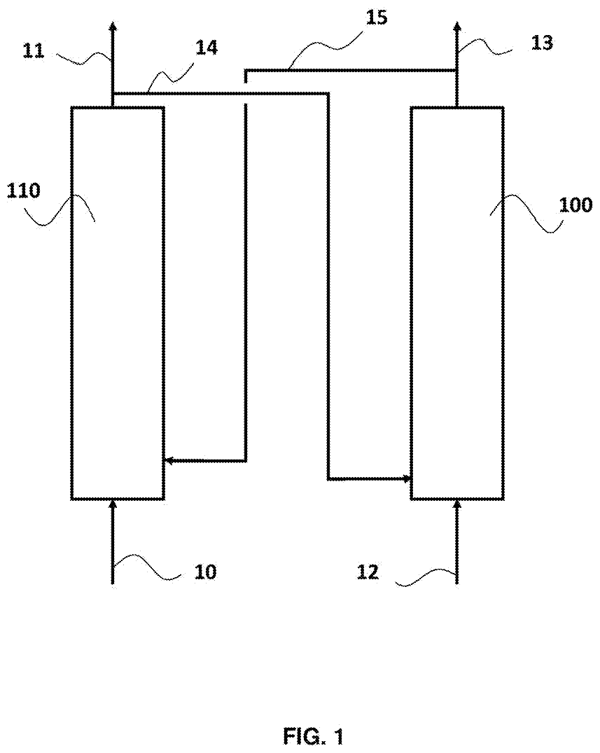

Before describing the combustion reactor according to the invention in more detail, the CLC process and plant employing such a reactor are described below, in connection with FIG. 1.

In the present description, the expressions “oxidation/reduction active mass” or, in abbreviated form, “active mass”, “oxygen transporter material”, “solid oxygen carrier” or “oxygen carrier” are equivalent. The oxidation/reduction mass is said to be active in connection with its reactive capacities, in the sense that it is capable of acting as oxygen transporter in the CLC process by capturing and releasing oxygen.

It should be noted that, in general, the terms oxidation and reduction are used in connection with the respectively oxidized or reduced state of the active mass. The oxidation reactor, also called air reactor, is that in which the oxidation/reduction mass is oxidized and the reduction reactor, also called fuel reactor or combustion reactor, is the reactor in which the oxidation/reduction mass is reduced. The reactors operate as fluidized bed and the active mass circulates between the oxidation reactor and the reduction reactor. The circulating fluidized bed technology is used to make possible the continuous passage of the active mass from its oxidized state in the oxidation reactor to its reduced state in the reduction reactor.

CLC Process and Plant According to the Invention

FIG. 1 is a diagram representing the general operating principle of chemical looping combustion. It does not in any way limit the CLC process and plant incorporating the combustion reactor according to the invention.

A reduced oxygen carrier 15 is brought into contact with an air stream 10 in a reaction zone 110 defined above as the oxidation reactor (or air reactor). This results in a stream of depleted air 11 and a stream of reoxidized particles 14. The stream of particles of oxidized oxygen carrier 14 is transferred into the reduction zone 100 defined above as the combustion reactor (or reduction reactor). The stream of particles 14 is brought into contact with a fuel 12, which is a hydrocarbon feedstock. This results in a combustion effluent 13 and a stream of particles of reduced oxygen carrier 15. For the sake of simplicity, the representation of FIG. 1 does not comprise the various items of equipment which can form part of the CLC unit, for solid/gas separation, solid/solid separation, heat exchange, pressurization, gastightness between reactors (e.g., siphons), storage of the solid, control of the solid streams (e.g., mechanical or pneumatic valves) or any recirculations of material around the oxidation and combustion reactors.

In the combustion zone 100, the hydrocarbon feedstock 12 is brought into contact cocurrentwise with the oxidation/reduction active mass in the form of particles in order to carry out the combustion of said feedstock by reduction of the oxidation/reduction active mass.

The oxidation/reduction active mass MₓO_{y}, M representing a metal, is reduced to the MₓO_{y-2n-m/2} state by means of the CₙHₘ hydrocarbon feedstock, which is correspondingly oxidized to give CO₂ and H₂O, according to the reaction (1) below, or optionally to give a CO+H₂ mixture, according to the proportions used.

CₙHₘ+MₓO_{y}→n CO₂+m/2 H₂O+MₓO_{y-2n-m/2}

The total combustion of the hydrocarbon feedstock is generally targeted.

The combustion of the feedstock in contact with the active mass is carried out at a temperature generally of between 600° C. and 1400° C., preferentially between 800° C. and 1000° C. The contact time varies depending on the type of combustible feedstock used. It typically varies between 1 second and 20 minutes, for example preferably between 1 minute and 10 minutes, and more preferentially between 1 minute and 8 minutes for a solid or liquid feedstock, and for example preferably from 1 to 20 seconds for a gaseous feedstock.

A mixture comprising the gases resulting from the combustion and the particles of the active mass is discharged at the top of the reduction zone 100. Gas/solid separation means (not represented), such as a cyclone, make it possible to separate the combustion gases 13 from the solid particles of the active mass in their most reduced state 15. In the case of the presence of unburnt residues which may occur if the hydrocarbon feedstock is solid, a solid/solid separation device making it possible to separate the particles of unburnt residues from the particles of the active mass can be employed at the outlet of the combustion reactor. This type of separator can be combined with one or more gas/solid separators arranged downstream of the solid/solid separator. The particles of the active mass which have stayed in the combustion reactor, and separated from the combustion gases, are sent to the oxidation zone 110 to be reoxidized. The unburnt residues can be recycled to the reduction reactor 100.

In the oxidation reactor 110, the active mass is restored to its MₓO_{y} oxidized state on contact with an oxidizing gas 10, typically air or water vapor, and preferably air, according to the reaction (2) below, before returning to the reduction reactor 100, and after having been separated from the oxygen-depleted gas 11, typically “depleted” air, discharged at the top of the oxidation reactor 110.

MₓO_{y-2n-m/2}+(n+m/4)O₂→MₓO_{y}

where n and m respectively represent the number of carbon and hydrogen atoms which have reacted with the active mass in the combustion reactor.

The temperature in the oxidation reactor is generally between 600° C. and 1400° C., preferentially between 800° C. and 1000° C.

The active mass, passing alternately from its oxidized form to its reduced form and vice versa, describes an oxidation/reduction cycle.

The hydrocarbon feedstocks (or fuels) treated can be solid or liquid hydrocarbon feedstocks. The solid feedstocks can be chosen from coal, coke, pet-coke, biomass, tar sands and household waste. The liquid feedstocks can be chosen from petroleum, bitumen, diesel or gasoline. Preferably, the hydrocarbon feedstock treated is a solid feedstock, as stated above.

The oxidation/reduction mass can be composed of metal oxides, such as, for example, oxides of Fe, Ti, Ni, Cu, Mn, Co or V, alone or as a mixture, which can originate from ores (for example ilmenite or pyrolusite) or be synthetic (for example copper oxide particles supported on alumina, CuO/Al₂O₃, or nickel oxide particles supported on alumina, NiO/Al₂O₄, preferably copper oxide particles supported on alumina, CuO/Al₂O₃), with or without binder, and exhibits the required oxidation/reduction properties and the characteristics necessary for carrying out the fluidization. The oxygen storage capacity of the oxidation/reduction mass is advantageously, depending on the type of material, between 0.5% and 15% by weight. Advantageously, the amount of oxygen effectively transferred by the metal oxide is between 0.5% and 3% by weight, which makes it possible to use only a fraction of the total oxygen transfer capacity, ideally less than 30% of the latter, in order to limit the risks of mechanical aging or of agglomeration of the particles. The use of a fraction only of the oxygen transportation capacity also has the advantage that the fluidized bed acts as a thermal ballast and thus smooths the variations in temperatures on the route of the oxygen carrier.

The active mass is in the form of fluidizable particles, belonging to groups A, B, C or D of the Geldart classification, alone or in combination. Preferably, the particles of the oxidation/reduction active mass belong to group B of the Geldart classification. By way of example, and in a nonlimiting way, the particles of group B used exhibit a particle size such that more than 90% of the particles have a size of between 100 μm and 500 μm, preferably of between 150 μm and 300 μm.

Preferably, the particles of the oxidation/reduction active mass, which can be metal oxides, which are synthetic or natural ores, supported or not, have a density of between 1000 kg/m³ and 5000 kg/m³ and preferentially between 1200 kg/m³ and 4000 kg/m³.

For example, the nickel oxide particles supported on alumina (NiO/NiAl₂O₄) generally exhibit a grain density of between 2500 and 3500 kg/m³, depending on the porosity of the support and on the nickel oxide content, typically of approximately 3200 kg/m³.

Ilmenite, an ore combining titanium and iron (titanium iron oxide), exhibits a density of 4700 kg/m³.

The oxidation/reduction active mass can undergo a phase of activation so as to increase its reactive capacities, which may consist of a phase of rise in temperature, preferably a gradual one, preferably under an oxidizing atmosphere (for example under air).

The oxidation and combustion reactors operate as fluidized beds. They each comprise at least one system for injection of a fluidization gas. In the combustion reactor, the fluidization gas can be CO₂, which can be CO₂ produced during the combustion and recycled, or water vapor. In the oxidation reactor, the fluidization gas is an oxidizing gas, preferably air.

The oxidation reactor preferably comprises a transport fluidized bed. Advantageously, the velocity of the gas (gas phase of the bed) is between 2 m/s and 15 m/s, and preferentially between 3 m/s and 10 m/s. By way of example, such a reactor can have a diameter of between 1 m and 6 m for a height of between 10 m and 30 m.

The combustion reactor 100 is configured so as to include an arrangement of a dense bed and of a transport bed. In particular, the combustion reactor 100 comprises a lower chamber comprising a dense fluidized bed, surmounted by an upper chamber comprising a transport fluidized bed. The upper chamber has a smaller passage section than that of the lower chamber, making it possible to accelerate and to transport the gas/particles mixture exiting from the lower chamber. Preferably, the velocity of the gas in the lower chamber is between 0.3 m/s and 3 m/s. Advantageously, the velocity of the gas in the upper chamber of the combustion reactor is between 3 m/s and 15 m/s.

By way of example, the combustion reactor 100 can have a diameter of between 1 m and 10 m, for a height of between 3 m and 40 m.

Preferably, the section ratio of the lower chamber to the upper chamber is between 2 and 15, preferentially from 3 to 10.

Dense fluidized bed is understood to mean an ebullated bed or a turbulent bed. The fraction by volume of solid in such a dense fluidized bed is generally between 0.25 and 0.50.

Dilute fluidized bed is understood to mean a transport bed. The fraction by volume of solid is generally less than 0.25.

The geometry of the reactors can be parallelepipedal, cylindrical or any other three-dimensional geometry preferably comprising a symmetry of revolution. Cylindrical refers to a cylinder of revolution.

Advantageously, the combustion reactor, in particular the lower and upper chambers, has a parallelepipedal, preferably rectangular, shape. In particular, the lower and upper chambers of the combustion reactor have such a shape. This reactor shape is well suited to an industrial implementation of the CLC comprising large-sized items of equipment. Large-sized is understood to mean reactors, the passage section of which is expressed in tens of m², over heights of several tens of meters. It makes it possible, for example, to facilitate the increase in scale of the CLC plant by a possible duplication of the reactor in one dimension in order to increase the capacity thereof. In addition, this particular geometry also has the advantage of simplifying the possible installation of refractory materials on the internal face in order to protect the wall, generally of metal, of the chamber of the reactor from high temperatures. Such refractory materials can be used in combination with standard steels for the purpose of limiting the manufacturing costs. For example, layers of reinforced refractory cement, typically having thicknesses generally of between 2 and 50 cm, generally in the vicinity of 20 cm, on the internal faces exposed to the flow and to the high temperatures make it possible to use standard steels for the external parts of the reactor. Bricks can also be used by way of refractory material on the internal faces of the walls of the chamber of the reactor.

The materials used to construct the reactors and its constituent elements (inlet(s), discharge point(s), outlet(s), and the like) can be chosen from refractory materials, for example of refractory concrete, refractory brick or ceramic type, high temperature steels, for example of Hastelloy®, Incoloy®, Inconel® or Manaurite® type, or conventional steels, for example of stainless steel or carbon steel type, combined with refractory materials or combined with cooling means, such as tubes in which a heat-exchange fluid circulate.

In the combustion reactor, the lower chamber comprises a dense fluidized bed and the upper chamber comprises a transport fluidized bed. Such a geometry is well suited to the combustion of solid or liquid feedstocks, in particular solid feedstocks, which require a contact time with the particles of the active mass sufficiently long to tend toward total combustion, and which involve a first phase of gasification of the solid or liquid feedstock (as dense fluidized bed), followed by combustion of the gasified feedstock (as dense fluidized bed and as transport fluidized bed). The gasification of the feedstock contributes to increasing the velocity of the gas in the lower chamber of substantially constant passage section. This increase in the velocity of the gas is also produced as a result of the narrower passage section in the upper chamber.

In the lower chamber of the combustion reactor, there is a change from a heterogeneous regime, giving rise to an ebullated bed constituting the dense bed of the lower chamber, to a turbulent regime with an increasing velocity of the gas, to achieve a transport regime in the upper chamber.

During this change in regimes in the lower chamber, the size of the bubbles can become very large, up to approaching the size of the passage section of the lower chamber, characterizing the plug-flow phenomenon during the transient plug-flow regime between the regime of the ebullated bed and the turbulent regime, and pose problems of fluctuation in pressure, of vibration, of temperature heterogeneity and of solid/gas mixing, as already described, harmful to the integrity of the CLC plant and the performance qualities of the CLC process.

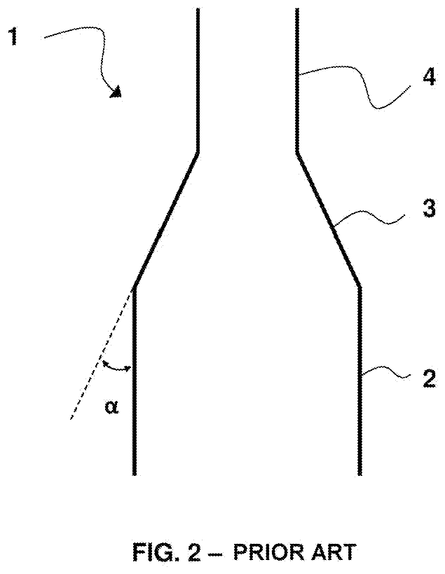

A known combustion reactor 1 is illustrated diagrammatically in FIG. 2. Such a combustion reactor is, for example, described in the application WO11151535. It comprises a lower chamber 2 comprising a dense bed and an upper chamber 4 comprising a dilute bed. The upper chamber 4 is of elongated shape and with a passage section strictly lower than that of the lower chamber, for example lower by at least 25% than that of the lower chamber, indeed even by at least 50%. This upper chamber 4 is a riser. The change in section makes it possible to increase the velocity between the lower chamber 2 and the upper chamber 4 and to ensure the transition between the dense-phase flow and the dilute-phase flow.

Thus, the lower chamber 2 comprises a feed pipe for the hydrocarbon feedstock, a pipe for feeding with particles of the active mass resulting from the oxidation reactor, a system for injection of a fluidization gas positioned at the base of the chamber 2, at a lower level than that of the feed pipes for the hydrocarbon feedstock and the particles of the active mass, and making possible the formation of the dense bed. For example, a fluidization gas is introduced by specific means which can be perforated plates arranged downstream of a distributor which can be a wind box fed by a pipe for feeding with said gas. These plates can be inclined by an angle generally of between 30° and 70° with respect to the horizontal and can leave in the central part a space free for the flow of the particles, making it possible to withdraw through the distributor a part of the particles sedimenting in this zone and consisting mainly of agglomerated ash.

The lower chamber 2 can also comprise one or more pipes for recycling particles of unburnt residues connected to solid/solid separation systems (devices for separation by elutriation) and/or gas/solid separation systems (e.g., cyclones).

For reasons of simplicity, not all these elements are represented in FIG. 2.

The upper chamber 4 comprises, at its top, a discharge point for the gas mixture comprising the combustion gases and the particles of the active mass, and possibly particles of unburnt residues and ash. The upper chamber 4 can also include a means for feeding with particles of active mass.

In the upper chamber 4, the combustion of the gaseous effluent resulting from the lower chamber 2 can be carried out. This gaseous effluent comprises the partially converted, indeed even completely converted, gasified solid feedstock. In view of the velocities of the gas, the mean residence time of the gas in this upper chamber 4 is generally between 1 second and 20 seconds, the mean residence time of the solids varying between 2 seconds and 1 minute. Under these conditions, and in view of the dilute nature of the flow and of the presence of the particles of the active mass of oxygen, the reactions are essentially reactions between the gas phase (gasified feedstock) and the particles of the active mass.

According to this known reactor 1, a pipe of variable section 3 makes it possible to make the junction between the lower chamber 2 and the upper chamber 4, and makes possible the discharge of the gaseous effluents and of the entrained particles toward the upper chamber 4. In the case of chambers of cylindrical shape, for example, this pipe is a cone 3. The wall of the cone 3 forms a nonzero angle α with the walls of the lower and upper chambers, i.e. with the vertical.

In such a configuration, the bubbles entraining the agglomerates of solids slide over the conical wall 3, are concentrated at the inlet of the upper chamber 4, and then cause, when they burst, strong fluctuations in pressure. Agglomerates of solids (or of solid particles) is understood to mean particles which have slightly agglomerated with one another to form clusters of larger size. These clusters can be entrained by the bubbles. The entrainment of agglomerates into the upper chamber 4 creates a flow which is not uniform, also causing fluctuations in pressure in the upper chamber 4. Finally, the entrainment of agglomerates of solid particles into the upper chamber 4 is harmful because these can in their turn cause plug-flow phenomena in the upper chamber 4, a phenomenon which is all the more likely to occur as the section is reduced.

Combustion Reactor According to the Invention

In order to reduce these strong fluctuations in pressure in the combustion reactor, and particularly in the upper chamber, a new combustion reactor is proposed.

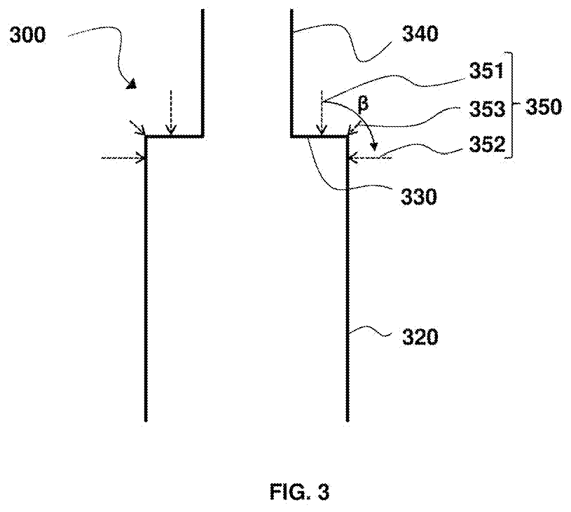

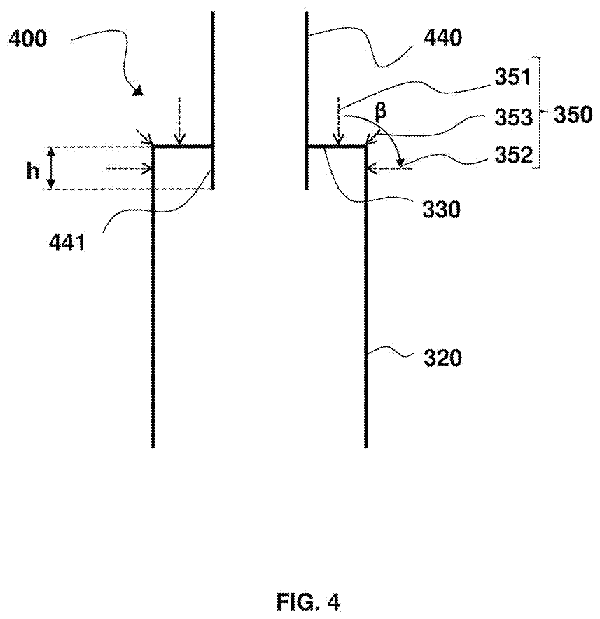

FIGS. 3 and 4 illustrate, diagrammatically and in a nonlimiting manner, two main embodiments of the combustion reactor according to the invention. In the figures, the same references denote identical or analogous elements.

With reference to FIG. 3, the combustion reactor 300 according to the invention is configured to operate as fluidized bed. It comprises:
a lower chamber 320 forming a first reaction zone for the combustion of a hydrocarbon feedstock in the presence of particles of an oxidation/reduction active mass, this lower chamber 320 comprising a first side wall and being configured to comprise a dense fluidized bed;
an upper chamber 340 of elongated shape and having a smaller passage section than the passage section of the lower chamber 320 (riser), forming a second reaction zone for the combustion of the gaseous effluents resulting from the combustion in the lower part 320, this upper chamber 340 comprising a second side wall and being configured to comprise a dilute fluidized bed;
an intermediate part 330 connecting the lower chamber 320 to the upper chamber 340, this intermediate part 330 comprising an internal wall forming a right angle with the first side wall of the lower chamber 320 and with the second side wall of the upper chamber 340.

This intermediate part constitutes in a way a flat ceiling for the lower chamber 320.

The abrupt restriction of passage section between the lower chamber 320 and the upper chamber 340, imposed by this specific right-angle geometry of the intermediate part 330 forming the connection between the two chambers of the combustion reactor, makes it possible to break up the agglomerates of solids before they enter the upper chamber 340, preventing the entrainment of agglomerates of solid particles into the riser of smaller section, thus limiting the fluctuations in pressure.

Internal wall of the intermediate part 330 is understood to mean the face of the wall forming this intermediate part 330 located inside the chamber 320, in contact with the fluidized bed. According to an alternative embodiment, the intermediate part 330 comprises an external wall, i.e. a face of the wall forming this intermediate part 330 located outside the chamber 320, which is slightly curved in order to facilitate the anchoring of a refractory material. The curvature can be of elliptical shape, and exhibit a ratio of the half-axes (ratio of the major axis to the minor axis) preferably of between 2 and 30, and more preferably of between 5 and 20.

The shape of the external wall can be of different shape, such as those described in the normative document NFE81-100 specific to dished ends. Examples of refractory materials have been given above in connection with the description of the CLC process and plant illustrated in FIG. 1. According to this alternative form, a flat roof for the lower chamber inside the reactor, that is to say a right angle for the junction inside the reactor (internal wall of the intermediate part 330) between the side wall of the lower chamber 320 and the side wall of the upper chamber 340, is well preserved.

The combustion reactor according to the invention can comprise other elements similar to those described above for the combustion reactor 1 according to the prior art, not represented in FIG. 3.

Thus, the lower chamber 320 advantageously comprises:
a feed pipe for the hydrocarbon feedstock;
a pipe for feeding with particles of the active mass resulting from the oxidation reactor;
a main injection system for a main fluidization gas positioned at its base. This main injection system is preferably located at a lower level than that of the feed pipes for the hydrocarbon feedstock and the particles of the active mass, and makes possible the formation of the dense bed. As for the lower chamber 2 of the reactor according to the prior art of FIG. 2, a fluidization gas is introduced by specific means which can be perforated plates arranged downstream of a distributor which can be a wind box fed by a pipe for feeding with said gas. These plates can be inclined by an angle generally of between 30° and 70° with respect to the horizontal and can leave in the central part a space free for the flow of the particles, making it possible to withdraw through the distributor a part of the particles sedimenting in this zone and consisting mainly of agglomerated ash.

The lower chamber 320 can additionally comprise one or more pipes for recycling particles of unburnt residues connected to solid/solid separation systems (devices for separation by elutriation) and/or gas/solid separation systems (e.g., cyclones).

The upper chamber 340 advantageously comprises a discharge point, at its top, for the gas mixture comprising the combustion gases and the particles of the active mass, and possibly particles of unburnt residues and ash.

The upper chamber 340 can also include a means for feeding with particles of active mass.

As for the upper chamber 4 of the reactor according to the prior art of FIG. 2, the upper chamber 340 can have a passage section lower by at least 25% than the passage section of the lower chamber 320, indeed even lower by at least 50%. The passage from the section of the lower chamber 320 to the reduced section of the upper chamber 340 makes it possible to increase the velocity of the flow between the two chambers and to ensure the transition between the dense-phase flow and the dilute-phase flow.

In the upper chamber 340, the combustion of the gaseous effluent resulting from the lower chamber 320 can be carried out. This gaseous effluent comprises the partially converted, indeed even completely converted, gasified solid feedstock. In view of the velocities of the gas, the mean residence time of the gas in this upper chamber is generally between 1 second and 20 seconds, the mean residence time of the solids varying between 2 seconds and 1 minute. Under these conditions, and in view of the dilute nature of the flow and of the presence of the particles of the active mass of oxygen, the reactions are essentially reactions between the gas phase (gasified feedstock) and the particles of the active mass.

Preferably, the upper chamber comprises a dilute fluidized bed having a fraction by volume of solid of less than 0.10.

According to an alternative form, the lower chamber 320 additionally comprises a secondary injection system 350 for a secondary fluidization gas positioned at the top of the lower chamber 320.

According to this alternative form, the secondary fluidization gas can be injected at the top of the lower chamber 320 of the combustion reactor 300, and preferably form at least one jet in the chamber along a direction forming an angle β of between 0 and 90° (values included) with the vertical. Thus, it is possible to carry out gas injections which are horizontal 352 (angle β equal to 90°), or vertical 351 (angle β equal to 0), or according to an angle β between these two values, being excluded, or according to a combination of these different directions.

These additional gas injections at the top of the upper chamber 320 make it possible to further reduce the fluctuations in pressure by breaking up the large solid agglomerates before their arrival in the upper chamber 340.

Advantageously, the flow rate of the secondary fluidization gas is less than 0.2×Q_{MG}, Q_{MG} being the flow rate of the main fluidization gas. Preferably, the flow rate of the secondary fluidization gas is between 0.02×Q_{MG} and 0.2×Q_{MG}, and more preferentially between 0.05×Q_{MG} and 0.15×Q_{MG}.

According to an alternative form, the lower chamber additionally comprises a tertiary injection system (not represented) for a tertiary fluidization gas positioned between the main injection system and the top of the lower chamber, configured to control the level of the dense bed. Thus, a tertiary fluidization gas is injected into a zone of the dense bed in the lower chamber of the combustion reactor so as to control the level of the dense bed, the entrainment of the solid particles being varied. In this way, it is possible to increase the distance between the surface of the bed and the inlet of the upper chamber 340, that is to say to have a greater disengagement zone height favoring the breaking up of the agglomerates of solids before the entry of the solid particles into the upper zone of lower section. It is recalled that the disengagement zone is the dilute zone above the dense bed (between the interface of the dense bed and the top of the chamber).

According to this alternative form, this injection can be done so as to form at least one jet in the chamber along a direction forming an angle of between 90°, value included (horizontal direction), and 180°, value excluded, with the vertical. Jets along several of these directions can also be produced.

The main fluidization gas can be CO₂, for example CO₂ produced during the combustion and recycled, or water vapor. The other, secondary and tertiary, fluidization gases can be of the same nature as the main fluidization gas and originate from the same source.

A combustion reactor 400 according to a second embodiment of the invention is illustrated in FIG. 4, and is in all respects identical to the reactor 300 described above in connection with FIG. 3, with the exception of the upper chamber 440, which comprises a penetrating segment 441 in the lower part of the chamber with a height h preferably of between 0.01×H and 0.3×H, H being the height of the lower chamber 320 of the combustion reactor.

As a nonlimiting example, the height H of the lower chamber 320 can be between 3 m and 40 m, for example be 20 m.

In the same way, as a nonlimiting example, the height of the upper chamber 440 can be between 3 m and 40 m, for example be 20 m.

The passage section of the lower chamber to passage section of the upper chamber ratio can be between 2 and 15, and preferentially between 3 and 10.

The same is true for the dimensions of the upper chamber 340 and lower chamber 320 of the reactor 300 according to the first embodiment.

The present invention also relates to the CLC plant comprising the combustion reactor according to the invention as described above, operating as fluidized bed to carry out the combustion of said hydrocarbon feedstock in contact with the particles of the oxidation/reduction active mass, and comprising the oxidation reactor operating as fluidized bed to oxidize the reduced particles of the oxidation/reduction active mass originating from the combustion reactor by bringing into contact with an oxidizing gas. The details on such a plant have already been given in connection with FIG. 1.

The present invention also relates to the CLC process employing the combustion reactor according to the invention as described above, and thus comprises the principals the following stages:
particles of an oxidation/reduction active mass are brought into contact with the hydrocarbon feedstock in the lower chamber of the combustion reactor within a dense fluidized bed formed by the injection of a main fluidization gas;
combustion of the gaseous effluent resulting from the lower chamber is carried out in the presence of particles of the oxidation/reduction active mass in the upper chamber of the combustion reactor, within a dilute fluidized bed;
oxidation of the particles of the oxidation/reduction active mass which have stayed in the combustion reactor is carried out within an oxidation reactor operating as fluidized bed before returning them to the combustion reactor.

The gaseous effluent resulting from the lower chamber comprises the gasified solid feedstock, as well as the effluents from the combustion carried out in the lower chamber. The upper chamber of the combustion reactor also receives the particles of the active mass resulting from the lower part, as well as possibly particles of unburnt residues and possibly fly ash, in particular in the case of combustion of solid feedstocks. Particles of unburnt residues is understood to mean the particles of the solid hydrocarbon feedstock which have not undergone total combustion and which consequently still contain hydrocarbon compounds. Ash is formed of noncombustible elements resulting from the total combustion of the particles of solid fuel for which the residence time in the combustion reactor has been sufficient. Ash is mainly inorganic in nature. It typically comprises the following compounds: SiO₂, Al₂O₃, Fe₂O₃, CaO, MgO, TiO₂, K₂O, Na₂O, SO₂, P₂O₅. It is characterized by a smaller particle size and a lower density than the particles of the active mass (i.e., less than 100 μm) and often also than the particles of unburnt residues.

Before being sent within the oxidation reactor for their oxidation, the particles of the oxidation/reduction active mass which have stayed in the combustion reactor are separated from the combustion gases by means of at least one solid/solid and/or solid/gas separator. Such separators are, for example, described in the patent applications WO11151535 and WO11151537. Solid/solid separator is understood to mean a device which makes possible the separation between two populations of solid particles: the particles of the oxygen carrier and the particles of unburnt residues which exit from the combustion reactor.

Thus, separation of particles of unburnt residues and particles of the oxidation/reduction active mass contained in the gas mixture comprising combustion gases resulting from the upper chamber of the combustion reactor can be carried out in a solid/solid particles separator, the particles of the oxidation/reduction active mass thus separated can be sent to the oxidation reactor, and the particles of unburnt residues, optionally separated from the combustion gases in at least one gas/solid separation stage, can be recycled in the combustion reactor.

The other details of such a CLC process have already been given above in the descriptive part in connection with FIG. 1.

1. A combustion reactor for chemical looping combustion configured to operate as fluidized bed comprising:
a lower chamber forming a first reaction zone for the combustion of a hydrocarbon feedstock in the presence of particles of an oxidation/reduction active mass, the lower chamber comprising a first side wall and being configured to comprise a dense fluidized bed;
an upper chamber of elongated shape and having a smaller passage section than the passage section of the lower chamber, forming a second reaction zone for the combustion of the gaseous effluents resulting from the combustion in the lower part, the upper chamber comprising a second side wall and being configured to comprise a dilute fluidized bed;
an intermediate part connecting the lower chamber to the upper chamber the intermediate part comprising an internal wall forming a right angle with the first side wall of the lower chamber and with the second side wall of the upper chamber.

2. The reactor as claimed in claim 1, in which the lower chamber comprises a main injection system for a main fluidization gas positioned at the base of the lower chamber.

3. The reactor as claimed in claim 2, in which the lower chamber additionally comprises a secondary injection system for a secondary fluidization gas positioned at the top of the lower chamber.

4. The reactor as claimed in claim 2, in which the lower chamber additionally comprises a tertiary injection system for a tertiary fluidization gas positioned between the main injection system and the top of the lower chamber, configured to control the level of the dense bed.

5. The reactor as claimed in claim 1, in which the upper part of the combustion reactor comprises a segment penetrating into the lower part of the chamber by a height h preferably of between 0.01×H and 0.3×H, H being the height of the lower chamber of the combustion reactor.

6. The reactor as claimed in claim 1, in which the ratio of the passage section of the lower chamber to the passage section of the upper chamber is between 2 and 15, and preferably between 3 and 10.

7. The reactor as claimed in claim 1, in which the lower and upper chambers of the reactor have a parallelepipedal, preferably rectangular, shape.

8. A plant for the chemical looping combustion of a hydrocarbon feedstock employing particles of an oxidation/reduction active mass circulating between a combustion reactor and an oxidation reactor, comprising:
the combustion reactor as claimed in claim 1 operating as fluidized bed to carry out the combustion of said hydrocarbon feedstock in contact with the particles of the oxidation/reduction active mass;
the oxidation reactor operating as fluidized bed in order to oxidize the reduced particles of the oxidation/reduction active mass originating from the combustion reactor by bringing into contact with an oxidizing gas.

9. A process for the chemical looping combustion of a hydrocarbon feedstock employing a combustion reactor as claimed in claim 1 or the plant as claimed in claim 8, comprising the following stages:
particles of an oxidation/reduction active mass are brought into contact with the hydrocarbon feedstock in the lower chamber of the combustion reactor within a dense fluidized bed formed by the injection of a main fluidization gas;
combustion of the gaseous effluents resulting from the lower chamber is carried out in the presence of particles of the oxidation/reduction active mass in the upper chamber of the combustion reactor, within a dilute fluidized bed;
oxidation of the particles of the oxidation/reduction active mass which have stayed in the combustion reactor is carried out within an oxidation reactor operating as fluidized bed before returning them to the combustion reactor.

10. The process as claimed in claim 9, in which the hydrocarbon feedstock is a solid feedstock, preferably chosen from coal, coke, pet-coke, biomass, tar sands and household waste.

11. The process as claimed in claim 10, in which separation of particles of unburnt residues and particles of the oxidation/reduction active mass contained in a gas mixture comprising combustion gases resulting from the upper chamber of the combustion reactor is carried out in a solid/solid particles separator, the particles of the oxidation/reduction active mass thus separated are sent to the oxidation reactor, and the particles of unburnt residues, optionally separated from the combustion gases in at least one gas/solid separation stage, are recycled in the combustion reactor.

12. The process as claimed in claim 9, in which the superficial velocity of the gas in the lower chamber of the combustion reactor is between 0.3 m/s and 3 m/s, and in which the superficial velocity of the gas in the upper chamber of the combustion reactor is between 3 m/s and 15 m/s.

13. The process as claimed in claim 9, in which the temperature in the combustion reactor is between 600° C. and 1400° C., preferably between 800° C. and 1000° C.

14. The process as claimed in claim 9, in which a secondary fluidization gas is injected at the top of the lower chamber of the combustion reactor, preferably forming a jet along a direction forming an angle β of between 0 and 90° with the vertical.

15. The process as claimed in claim 14, in which the flow rate of the secondary fluidization gas is between 0.02×Q_{MG} and 0.2×Q_{MG}, Q_{MG} being the flow rate of the main fluidization gas.

16. The process as claimed in claim 9, in which a tertiary fluidization gas is injected into a zone of the dense bed in the lower chamber of the combustion reactor so as to control the level of the dense bed.

17. The process as claimed in claim 9, in which the particles of the oxidation/reduction active mass belong to group B according to the Geldart classification.
